(19) United States
(12) Patent Application Publication
(10) Pub. No.: US 2026/0283905 A1
(43) Pub. Date: Sep. 24, 2026

(54) SHEARING TYPE MEDICINE CUTTER

(71) Applicant: Huizhou Yixiang Technology Co., Ltd., Huizhou City (CN)

(72) Inventor: MINGYOU WEN, Huizhou City (CN)

(21) Appl. No.: 19/417,326

(22) Filed: Dec. 12, 2025

(30) Foreign Application Priority Data
Mar. 18, 2025 (CN) 202520470663.3

(51) Int. Cl. A61J 7/00; B26D 3/30

(52) U.S. Cl. CPC A61J 7/0007; B26D 3/30

(57) ABSTRACT

A shearing type medicine cutter is provided, which includes an upper cover, a bottom shell, and a blade protection member. The upper cover and the bottom shell are connected by a rotating shaft, one end of the blade protection member is flexibly connected to the upper cover; the upper cover is provided with an upper blade structure and a protective component connection part. The protective component connection part is provided with an L-shaped protective component movement groove, one end of the blade protection member is flexibly connected to the L-shaped protective component movement groove; the bottom shell is provided with a workbench, a lower blade structure, and a tablet fixing component. The lower blade structure and tablet fixing component are both provided on the workbench, and one end of the upper blade structure can pass through the blade protection member and move towards the lower blade structure.

### CROSS-REFERENCE TO RELATED APPLICATIONS

This application claims priority to Chinese Patent Application No. 202520470663.3, filed on Mar. 18, 2025, which is hereby incorporated by reference in its entirety.

### TECHNICAL FIELD

The present disclosure relates to the field of pill cutter technologies, and in particular, to a shearing type medicine cutter.

### BACKGROUND

In a process of daily medication, it is often necessary to cut pills according to different doses according to personal needs, and a medicine cutter is generally used to cut the pills. At present, most medicine cutters on the market install a blade protection structure by installing a blade protection member seat with a torsion spring around an upper blade. Although this design can also protect a blade, the torsion spring is prone to torque attenuation and other problems after use for a period of time, which poses a safety hazard of blade leakage and high maintenance costs. Moreover, most of the medicine cutters on the market adopt unidirectional cutting design, which often fails to ensure a flatness of the cutting surface and an integrity of the tablets, rendering them prone to breakage and surface cracks during the cutting process, thereof affecting cutting accuracy and efficacy.

Therefore, how to provide a shearing type medicine cutter is an urgent problem that technical personnel in this field need to solve.

The purpose of the present disclosure is to provide a shearing type medicine cutter, aimed at solving the above technical problems. The shearing type medicine cutter of the present disclosure can hide an upper blade when an upper cover is provided, effectively avoiding leakage of the upper blade and improving safety, with the cooperation of the blade protection member and the L-shaped protective component movement groove. Simultaneously provided with an upper blade structure and a lower blade structure, upper and lower surfaces of the tablet are simultaneously subjected to a cutting force of the sharp blade, thereof achieving a combined force of upper and lower blades for cutting. During a cutting process, the tablet may experience problems such as fragmentation, cracks, and deviation, resulting in good cutting effect and strong practicality.

In order to achieve the above objectives, the present disclosure is implemented through the following technical solutions.

A shearing type medicine cutter, including an upper cover, a bottom shell, and a blade protection member; the upper cover and the bottom shell are connected by a rotating shaft, and one end of the blade protection member is flexibly connected to the upper cover;

the upper cover is provided with an upper blade structure and a protective component connection part; the protective component connection part is provided with an L-shaped protective component movement groove, and one end of the blade protection member is flexibly connected to the L-shaped protective component movement groove;

the bottom shell is provided with a workbench, a lower blade structure, and a tablet fixing component; the lower blade structure and the tablet fixing component are both provided on the workbench, and one end of the upper blade structure is configured to pass through the blade protection member and move in a direction of the lower blade structure.

In some embodiments of the present disclosure, the blade protection member is provided with an upper rotatable connection part, an upper blade perforation, and a lower rotatable connection seat, the upper rotatable connection part is flexibly connected to the L-shaped protective component movement groove, and the lower rotatable connection seat is rotatably connected to an anti-detachment component.

In some embodiments of the present disclosure, the lower blade structure includes a lower blade and an elastic tablet support platform, the tablet support platform is provided on the workbench, the tablet support platform is provided with a lower blade perforation, a lower end of the lower blade is provided on the workbench, and an upper end of the lower blade extends outward through the lower blade perforation.

In some embodiments of the present disclosure, the upper blade structure includes an upper blade support seat and an upper blade provided on the upper blade support seat, and one end of the upper blade is configured to pass through the upper blade perforation and move in a direction of the tablet support table.

In some embodiments of the present disclosure, the tablet fixing component is made of plastic material and includes a sliding base, a left tablet fixing component, a right tablet fixing component, and a front tablet fixing component, where the sliding base is provided between the workbench and the bottom shell.

In some embodiments of the present disclosure, the sliding base is provided with a left arc-shaped hole, a right arc-shaped hole, and a front arc-shaped hole, a lower end of the left tablet fixing component moves within the left arc-shaped hole, a lower end of the right tablet fixing component moves within the right arc-shaped hole, and a lower end of the front tablet fixing component moves within the front arc-shaped hole.

In some embodiments of the present disclosure, the workbench is further provided with a left guide hole, a right guide hole, and a front guide hole, a lower end of the left tablet fixing component is inserted into the left arc-shaped hole through the left guide hole, a lower end of the right tablet fixing component is inserted into the right arc-shaped hole through the right guide hole, and a lower end of the front tablet fixing component is inserted into the front arc-shaped hole through the front guide hole.

In some embodiments of the present disclosure, the anti-detachment component is provided on the workbench, and the anti-detachment component is connected to the lower rotatable connection seat.

The present disclosure has the following beneficial effects.
1. The present disclosure relates to a shearing type medicine cutter, which is provided with an L-shaped protective component movement groove. When the cover is closed, the upper rotatable connection part is provided in a vertical groove of the L-shaped protective component movement groove. When the cover is opened, the upper rotatable connection part is provided in a transverse groove of the L-shaped protective component movement groove. At this time, the blade protection member can hide the upper blade, thereby effectively avoid the leakage of the upper blade and improve safety.
2. The present disclosure provides the shearing type medicine cutter, which is provided with an upper blade structure and a lower blade structure, namely sharp upper and lower blades. When pressing and cutting the medicine tablet, upper and lower surfaces of the tablet are simultaneously subjected to a cutting force of the sharp blade, thereby achieving a joint force cutting of the upper and lower blades, dividing the tablet and reducing the probability of fragmentation caused by excessive contact surface during the pressing and cutting process. The use effect is good, thereof avoiding problems such as fragmentation and skewed cracks in the tablet during a cutting process.

### BRIEF DESCRIPTION OF DRAWINGS

FIG. 1 is a first schematic diagram of an overall structure of the present disclosure.

FIG. 2 is a second schematic diagram of the overall structure of the present disclosure.

FIG. 3 is a first disassembly schematic diagram of a bottom shell, a workbench, and a tablet fixing component shown in FIG. 1.

FIG. 4 is a second disassembly schematic diagram shown in FIG. 3.

FIG. 5 is a schematic diagram of a structural disassembly of an upper cover and a blade protection member shown in FIG. 1.

FIG. 6 is a schematic structural sectional view of the upper cover and blade protection member shown in FIG. 5.

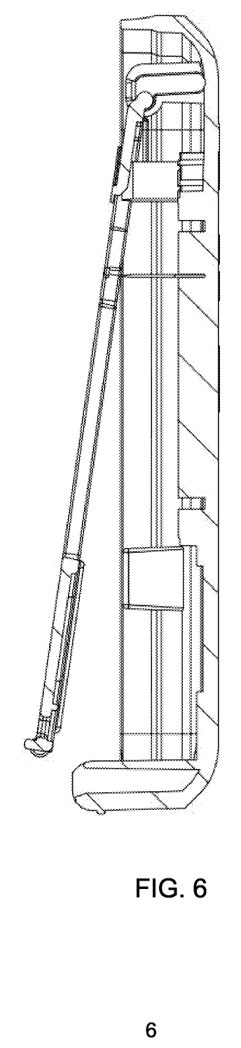

Numeral reference: 1- upper cover; 2- bottom shell; 3- blade protection member; 4- upper blade structure; 5- protective component connection part; 50- L-shaped protective component movement groove; 6- workbench; 7- lower blade structure; 8- tablet fixing component; 30- upper rotatable connection part; 31- upper blade perforation; 32- lower rotatable connection seat; 70- lower blade; 71- tablet support platform; 72- lower blade perforation; 40- upper blade support seat; 41- upper blade; 80- sliding base; 81- left tablet fixing component; 82- right tablet fixing component; 83- front tablet fixing component; 84- left arc-shaped hole; 85- front arc-shaped hole; 60- left guide hole; 61- front guide hole; 62- left limit slot; 63- limit column; 801- rotatable hole; 20- limit connection column; 21- movement hole; 86- movement part; 9- anti-detachment component; 320- pull buckle perforation; 321- lower rotatable connecting part; 90- pull buckle block; 91- front blocking block; 92- rear blocking block; 64- plug in buckle.

### DESCRIPTION OF EMBODIMENTS

In order to enable personnel in this technical field to better understand the technical solution of the present disclosure, further detailed explanations of the product of the present disclosure will be provided below in combination with the embodiments and accompanying drawings.

It should be noted that when a component is referred to as “fixed to” another component, it can be directly on the other component or there can also be a centered component. When a component is considered to be “connected” to another component, it can be directly connected to another component or there may be a central component present at the same time. Terms “vertical”, “horizontal”, “left”, “right” and similar expressions used in this specification are for illustrative purposes only and do not represent the only implementation mode.

Unless otherwise defined, all technical and scientific terms used in this specification have the same meanings as those commonly understood by those skilled in the art belonging to the present disclosure. The terms used in this specification of the present disclosure are only for the purpose of describing specific embodiments and are not intended to limit the present disclosure. Terms “and/or” used in this specification include any and all combinations of one or more related listed items.

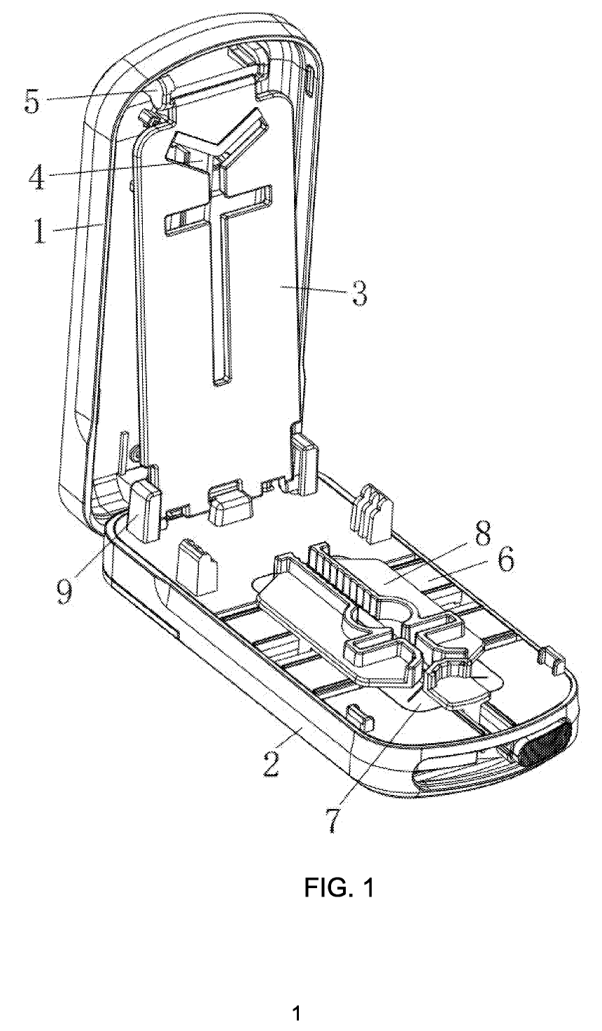

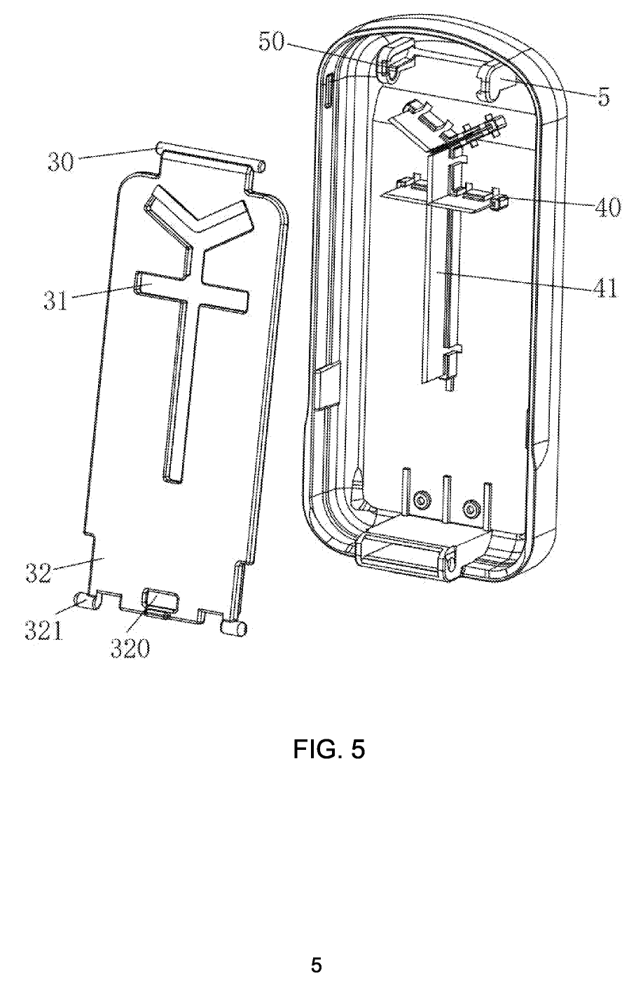

As shown in FIGS. 1 and 5, a shearing type medicine cutter includes an upper cover 1, a bottom shell 2, and a blade protection member 3. The upper cover 1 and the bottom shell 2 are connected by rotating a cover through a rotating shaft, and one end of the blade protection member 3 is flexibly connected to the upper cover 1.

The upper cover 1 is provided with an upper blade structure 4 and a protective component connection part 5. The protective component connection part 5 is provided with an L-shaped protective component movement groove 50, and one end of the blade protection member 3 is flexibly connected to the L-shaped protective component movement groove 50.

The bottom shell 2 is provided with a workbench 6, a lower blade structure 7, and a tablet fixing component 8. Both the lower blade structure 7 and the tablet fixing component 8 are provided on the workbench 6. One end of the upper blade structure 4 can pass through the blade protection member and move in a direction of the lower blade structure 7.

As shown in FIG. 5, the blade protection member 3 is provided with an upper rotatable connection part 30, an upper blade perforation 31, and a lower rotatable connection seat 32. The upper rotatable connection part 30 is flexibly connected to the L-shaped protective component movement groove 50, and the lower rotatable connection seat 32 is rotatably connected to an anti-detachment component 9.

It should be noted that by providing the L-shaped protective component movement groove 50, when the upper cover is closed, the upper rotatable connection part 30 is provided in a vertical groove of the L-shaped protective component movement groove 50. When the upper cover 1 is opened, the upper rotatable connection part 30 is provided in a horizontal groove of the L-shaped protective component movement groove 50. At this time, the blade protection member 3 can hide the upper blade 41, thereby effectively avoiding a leakage of the upper blade 41 and improving safety.

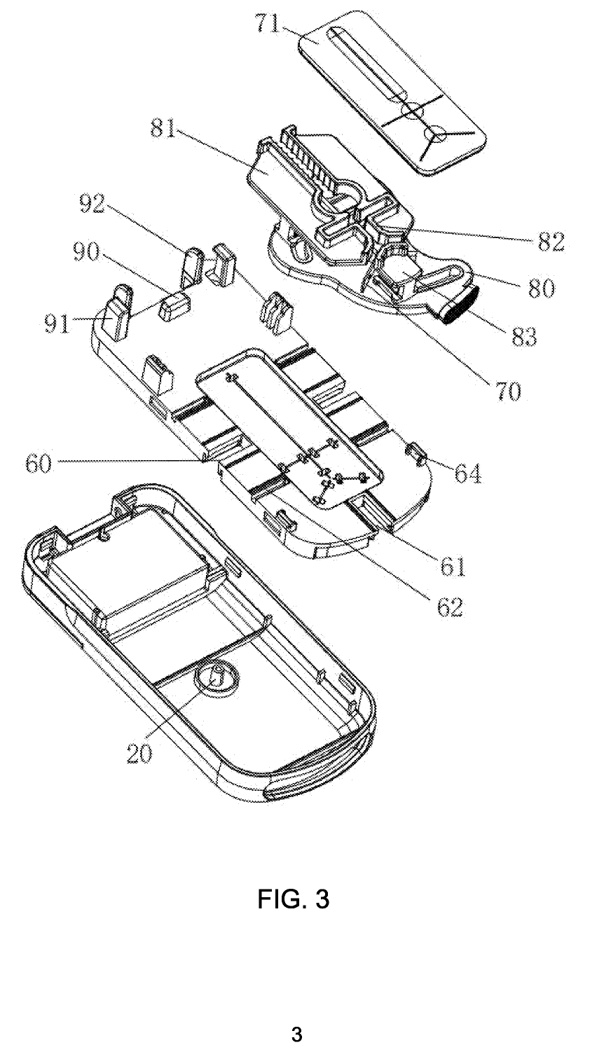

As shown in FIG. 3, the lower blade structure 7 includes a lower blade 70 and an elastic tablet support platform 71. The tablet support platform 71 is provided on the workbench 6, and a lower blade perforation 72 is provided on the tablet support platform 71. A lower end of the lower blade 70 is provided on the workbench 6, and an upper end of the lower blade 70 extends outward through the lower blade perforation 72.

It should be noted that the tablet support platform 71 is made of elastic plastic material. When cutting tablets, the elastic tablet support platform 71 will undergo a compression motion under a force of a tablet, the lower blade structure 7 is caused to contact the tablets for segmentation motion.

It should be further explained that when no pressing is used, the lower blade 70 is hidden under a surface of the tablet support table 71. After placing the tablet, the upper cover 1 is pressed to move the upper blade 41 of the upper cutting blade structure downwards. The tablet support table 71 moves downwards under a pressing force of the tablet, thereby promoting double-sided simultaneous cutting of the tablet, that is, achieving a joint force cutting of the upper blade 41 and the lower blade 70.

As shown in FIG. 5, the upper blade structure 4 includes an upper blade support seat 40 and an upper blade 41 provided on the upper blade support seat 40. One end of the upper blade 41 can pass through the upper blade perforation 31 and move towards a direction of the tablet support table 71.

It should be noted that the present disclosure provides the upper blade structure 4 and the lower blade structure 7, namely a sharp upper blade 41 and a lower blade 70. When pressed and used, upper and lower surfaces of the tablet are simultaneously subjected to a cutting force of sharp blades, thereby achieving a combined cutting force of the upper and lower blades 70, and dividing the tablet. The use effect is good, avoiding problems such as fragmentation, cracking, and deviation of the tablet during the segmentation process.

It should be further explained that the upper blade 41 and the lower blade 70 of this embodiment are both composed of blades in the shape of a “cross” and a “Y”, which are convenient for cutting tablets of different shapes and cutting them in multiple directions. They are flexible and convenient to use, improve usability, have diverse functions, and are highly practical.

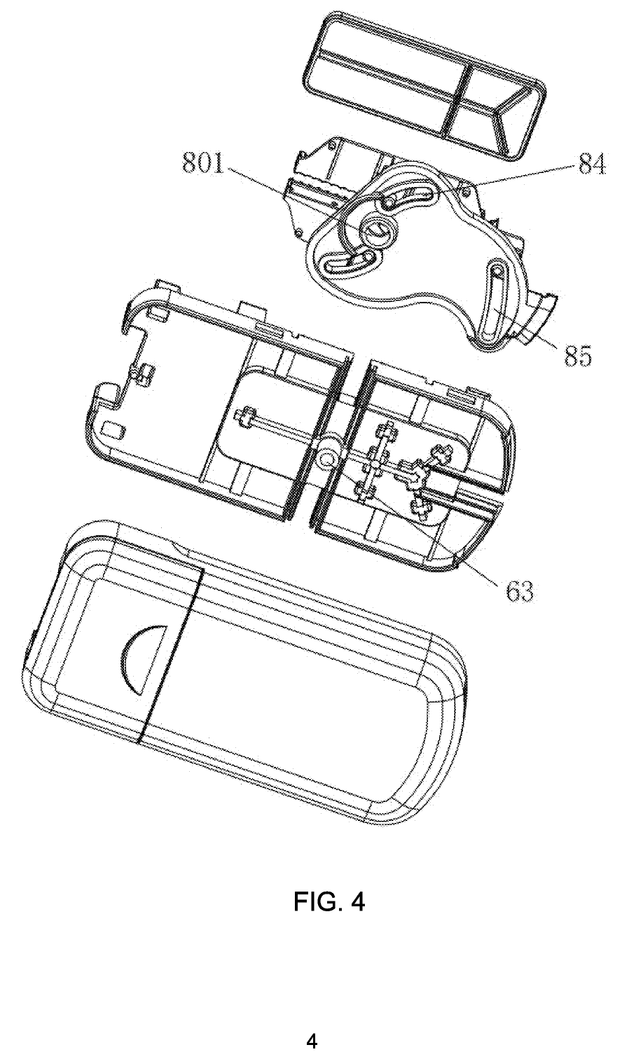

As shown in FIGS. 3 and 4, the tablet fixing component 8 is made of plastic, which includes a sliding base 80, a left tablet fixing component 81, a right tablet fixing component 82, and a front tablet fixing component 83. The sliding base 80 is provided between the workbench 6 and the bottom shell 2.

It should be noted that the left tablet fixing component 81, the right tablet fixing component 82, and the front tablet fixing component 83 are all provided with push-pull parts, which facilitate the movement of the left tablet fixing component 81, the right tablet fixing component 82, and the front tablet fixing component 83. A “cross” shaped tablet placement position is formed between the left tablet fixing component 81 and the right tablet fixing component 82, and a “Y” shaped tablet placement position is formed between the left tablet fixing component 81, the right tablet fixing component 82, and the front tablet fixing component 83, which facilitates cutting of tablets of different shapes and cutting of tablets in multiple directions, rendering it flexible and convenient to use.

As shown in FIGS. 3 and 4, the sliding base 80 is provided with a left arc-shaped hole 84, a right arc-shaped hole, and a front arc-shaped hole 85. A lower end of the left tablet fixing component 81 moves within the left arc-shaped hole 84, a lower end of the right tablet fixing component 82 moves within the right arc-shaped hole, and a lower end of the front tablet fixing component 83 moves within the front arc-shaped hole 85.

As shown in FIGS. 3 and 4, the workbench 6 is further provided with a left guide hole 60, a right guide hole, a front guide hole 61, a left limit slot 62, and a right limit groove. A lower end of the left tablet fixing component 81 is inserted into the left arc-shaped hole 84 through the left guide hole 60, a lower end of the right tablet fixing component 82 is inserted into the right arc-shaped hole through the right guide hole, and a lower end of the front tablet fixing component 83 is inserted into the front arc-shaped hole 85 through the front guide hole 61.

As shown in FIGS. 3 and 4, a lower end of the workbench 6 is provided with a limit column 63, and the sliding base 80 is provided with a rotatable hole 801. The bottom shell 2 is provided with a limit connection column 20, and the limit connection column 20 is connected to the limit column 63. The sliding base 80 is connected to the limit column 63 through the rotatable hole 801, and through a cooperation of the limit column 63, the limit connection column 20, and the rotatable hole 801, the sliding base 80 can rotate and move between the workbench 6 and the bottom shell 2.

It should be noted that when the left tablet fixing component 81, the right tablet fixing component 82, and the front tablet fixing component 83 are moved, the sliding base 80 also rotates accordingly. With a cooperation between the left arc-shaped hole 84, the right arc-shaped hole, the front arc-shaped hole 85, the first guide hole, the second guide hole, and the third guide hole, the tablets can be freely fixed, rendering it convenient to adapt to tablets of different sizes and flexible to use.

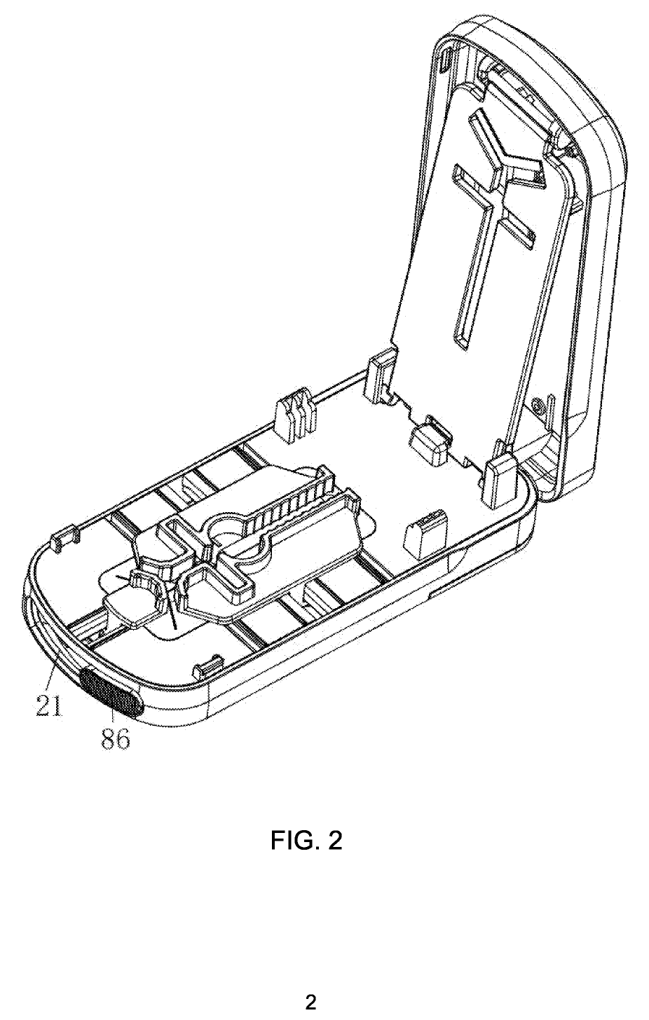

As shown in FIG. 2, a front side of the bottom shell 2 is further provided with a movement hole 21, and a front end of the sliding base 80 is provided with a movement part 86, and the movement part 86 can be flexibly provided in the movement hole 21. By moving the movement part 86 left and right, the left tablet fixing component 81, the right tablet fixing component 82, and the front tablet fixing component 83 can be simultaneously opened or closed, which is conducive to taking and placing tablets and improves convenience.

As shown in FIG. 1, the workbench 6 is provided with the anti-detachment component 9, and the anti-detachment component 9 is connected to the lower rotating connecting seat 32.

As shown in FIG. 5, the lower rotatable connection seat 32 is provided with a pull buckle perforation 320 and a lower rotatable connecting part 321.

As shown in FIGS. 3 to 5, the anti-detachment component 9 includes a pull buckle block 90, a front blocking block 91, and a rear blocking block 92. The front blocking block 91 and the rear blocking block 92 are symmetrically provided on two sides of the pull buckle block 90. The rear blocking block 92 is in movable contact with the lower rotatable connection seat 32 of the blade protection member 3. The front blocking block 91 is rotatably connected to the lower rotatable connecting part 321, and the pull buckle block 90 is rotatably connected to the pull buckle perforation 320.

As shown in FIGS. 3 to 5, the pull buckle block 90 has a “T” shape, and includes a horizontal part and a vertical part. When the upper cover 1 is opened and closed, a transverse part of the pull buckle block 90 is pressed against the pull buckle perforation 320 to prevent the blade protection member 3 from dislodging. When the upper cover 1 is closed, a vertical part of the pull buckle block 90 is inserted into the pull buckle perforation 320, thereby playing a limiting and fixing role to prevent the blade protection member 3 from dislodging.

It should be noted that a position of the blade protection member 3 can be limited and fixed by the cooperation of the pull buckle block 90, the front blocking block 91, the rear blocking block 92, and the blade protection member 3, thereby avoiding a dislocation of the blade protection member 3 and ensuring high safety during use.

As shown in FIG. 3, an upper surface of the workbench 6 is further provided with a plug-in buckle 64, and an inner wall of the upper cover 1 is provided with a fastening groove that is compatible with the plug-in buckle 64, thereby improving a connection stability between the upper cover 1 and the bottom shell 2.

The above description is only a preferred embodiment of the present disclosure and does not limit the present disclosure in any form; those skilled in the art can smoothly implement the present disclosure as shown in the accompanying drawings and described above. However, any equivalent changes, modifications, and evolutions made by technical personnel familiar with this field without departing from the scope of the technical solution disclosed above are equivalent embodiments of the present disclosure. Meanwhile, any equivalent changes, modifications, and evolutions made to the above embodiments based on the essential technology of the present disclosure still fall within the protection scope of the technical solution of the present disclosure.

What is claimed is:

1. A shearing type medicine cutter, comprising an upper cover, a bottom shell, and a blade protection member;
the upper cover and the bottom shell are connected by a rotating shaft, and one end of the blade protection member is flexibly connected to the upper cover;
the upper cover is provided with an upper blade structure and a protective component connection part; the protective component connection part is provided with an L-shaped protective component movement groove, and one end of the blade protection member is flexibly connected to the L-shaped protective component movement groove;
the bottom shell is provided with a workbench, a lower blade structure, and a tablet fixing component;
the lower blade structure and the tablet fixing component are both provided on the workbench, and one end of the upper blade structure is configured to pass through the blade protection member and move in a direction of the lower blade structure.

2. The shearing type medicine cutter according to claim 1, wherein the blade protection member is provided with an upper rotatable connection part, an upper blade perforation, and a lower rotatable connection seat, the upper rotatable connection part is flexibly connected to the L-shaped protective component movement groove, and the lower rotatable connection seat is rotatably connected to an anti-detachment component.

3. The shearing type medicine cutter according to claim 2, wherein the lower blade structure comprises a lower blade and an elastic tablet support platform, the tablet support platform is provided on the workbench, the tablet support platform is provided with a lower blade perforation, a lower end of the lower blade is provided on the workbench, and an upper end of the lower blade extends outward through the lower blade perforation.

4. The shearing type medicine cutter according to claim 3, wherein the upper blade structure comprises an upper blade support seat and an upper blade provided on the upper blade support seat, and one end of the upper blade is configured to pass through the upper blade perforation and move in a direction of the tablet support table.

5. The shearing type medicine cutter according to claim 4, wherein the tablet fixing component is made of plastic material, comprises a sliding base, a left tablet fixing component, a right tablet fixing component, and a front tablet fixing component,
wherein the sliding base is provided between the workbench and the bottom shell.

6. The shearing type medicine cutter according to claim 5, wherein the sliding base is provided with a left arc-shaped hole, a right arc-shaped hole, and a front arc-shaped hole,
a lower end of the left tablet fixing component moves within the left arc-shaped hole, a lower end of the right tablet fixing component moves within the right arc-shaped hole, and a lower end of the front tablet fixing component moves within the front arc-shaped hole.

7. The shearing type medicine cutter according to claim 6, wherein the workbench is further provided with a left guide hole, a right guide hole, and a front guide hole,
a lower end of the left tablet fixing component is inserted into the left arc-shaped hole through the left guide hole,
a lower end of the right tablet fixing component is inserted into the right arc-shaped hole through the right guide hole, and a lower end of the front tablet fixing component is inserted into the front arc-shaped hole through the front guide hole.

8. The shearing type medicine cutter according to claim 1, wherein the anti-detachment component is provided on the workbench, and the anti-detachment component is connected to the lower rotatable connection seat.
